(19) United States
(12) Patent Application Publication
(10) Pub. No.: US 2019/0281813 A1
(43) Pub. Date: Sep. 19, 2019

(54) REVOLVING TREE STAND SYSTEM

(71) Applicant: Ronald Johnson, Pollard, AR (US)

(72) Inventor: Ronald Johnson, Pollard, AR (US)

(21) Appl. No.: 16/253,184

(22) Filed: Jan. 21, 2019

Related U.S. Application Data
(60) Provisional application No. 62/619,559, filed on Jan. 19, 2018.

(51) Int. Cl. A01M 31/02

(52) U.S. Cl. CPC A01M 31/02

(57) ABSTRACT

A revolving tree stand system including a hanger-member, a seat, and a shooting rail, a foot platform assembly having a platform plate, a lower support arm assembly, a first-side mounting plate, a second-side mounting plate, and a tree-hugger assembly, and a hanger assembly including an extension arm, a hook, and gripping members. The hanger assembly receives and supports the seat assembly in a suspended position. The seat assembly is configured to support a user on the seat and the platform plate further supports the user. The revolving tree stand system provides a 360 degree rotatable tree hanger.

### CROSS REFERENCE TO RELATED APPLICATION

The present application is related to and claims priority to U.S. Provisional Patent Application No. 62/619,559 filed Jan. 19, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of hunting accessories and more specifically relates to tree stands.

### 2. Description of Related Art

Tree stands may be used for hunting. Conventional tree stands present several issues for the hunter. They can decrease a hunter's view of the hunting area and can make it difficult for hunters to change positions quickly and smoothly. They also require the hunter to sit and then stand up when shooting. This motion cannot only spook game but can also be dangerous to the hunter. A suitable solution is desired.

U.S. Pub. No. 2009/0321186 to Joel J. Louchart relates to a swivel tree stand. The described swivel tree stand includes a tree stand having a platform a superstructure pivotally secured to the platform and a series of support bearings interconnected by a first arm and a second consecutive arm. The second aim terminates in a seat, the bearings facilitating ease of repositioning and angle adjustability for left and right banded hunters seeking to aim at game on opposite sides.

### BRIEF SUMMARY OF THE INVENTION

In view of the foregoing disadvantages inherent in the known hunting accessories art, the present disclosure provides a novel revolving tree stand system. The general purpose of the present disclosure, which will be described subsequently in greater detail, is to provide a fully rotating tree stand.

A revolving tree stand system is disclosed herein. The revolving tree stand system includes a seat assembly including a hanger-member, a seat, and a shooting rail, a foot platform assembly having a platform plate, a lower support arm assembly, a first-side mounting plate, a second-side mounting plate, and a tree-hugger assembly, and a hanger assembly including an extension arm, a hook, and gripping members. The hanger assembly and the foot platform assembly are configured to mount to a tree trunk using the gripping members and the tree-hugger assembly respectively, a first-chain, and second-chain. The first-chain is configured to mount the hanger assembly to the tree and the second-chain is configured to mount the foot platform assembly to the tree trunk. The extension arm is connected to and extends from the gripping members and includes the hook at a distal end. The hanger assembly is configured to receive and support the seat assembly in a suspended position via the hook connecting with the hanger-member. The seat assembly is configured to support a user on the seat and the platform plate further supports the user. The revolving tree stand system provides a 360 degree rotatable tree hanger.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a revolving tree stand system, constructed and operative according to the teachings of the present disclosure.

FIG. 1 is a perspective view of the revolving tree stand system during an ‘in-use’ condition, according to an embodiment of the disclosure.

FIG. 2 is a perspective view of the revolving tree stand system of FIG. 1, including a hanger assembly, seat assembly, and foot platform assembly according to an embodiment of the present disclosure.

FIG. 3 is a perspective view of the revolving tree stand system of FIG. 1, showing the hanger assembly supporting the seat assembly according to an embodiment of the present disclosure.

FIG. 4 is a perspective view of the foot platform assembly of the revolving tree stand system of FIG. 1, according to an embodiment of the present disclosure.

FIG. 5 is a view of a kit of the revolving tree stand system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to hunting accessories and more particularly to a revolving tree stand system as used to improve the efficient and effective use of tree stands.

Generally, the present invention provides a revolving tree stand that allows a hunter to easily change position while in the stand. It improves a hunter's safety while giving the user the advantage. The device affords the user the ability to change shooting positions without accidentally alerting game and without standing up. It rotates the hunter either direction 360 degrees with minimal motion and minimal friction from the swivel. The present invention comprises a platform over which a hanging chair suspended from a metal swivel is disposed. SILENT 360 HANG ON is a revolving tree stand for use by hunters that enable the user to rotate their position in either direction quickly and quietly. The invention is comprised of a hanger, chair, and platform that are attached to the tree by use of an attached chain and binder. The chair attaches to the hanger with a safety latch lock. A swivel is included to minimize friction and allow for 360 degree rotations in either direction. The swivel is attached to the upper hanger, and the safety hook is attached to it. The assembly is available in multiple sizes.

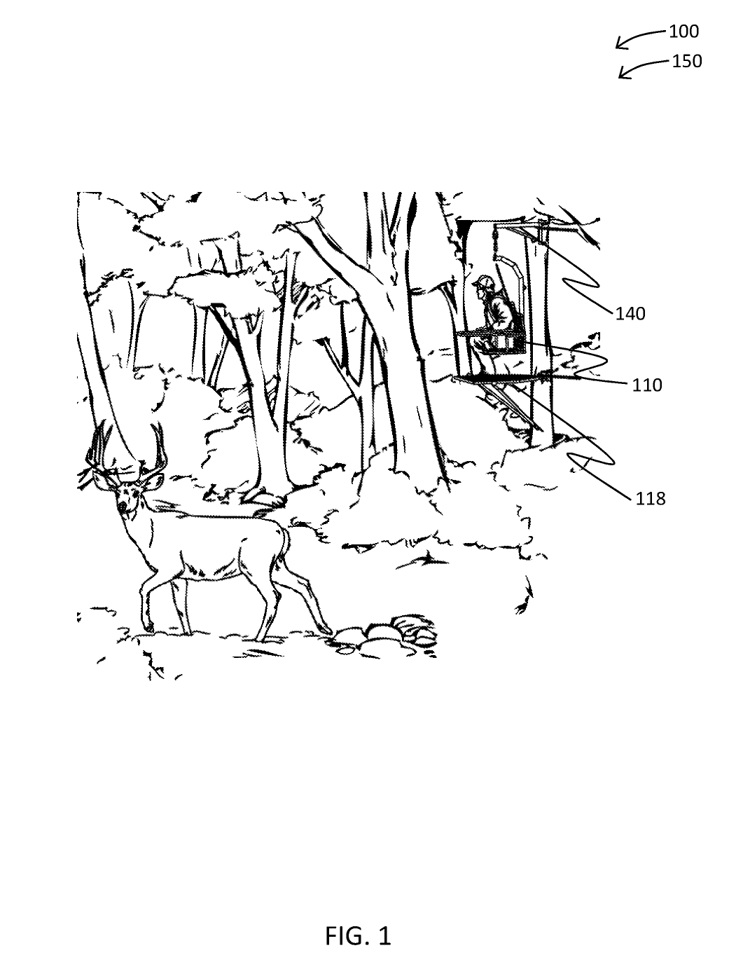

Referring now more specifically to the drawings by numerals of reference, there is shown in FIGS. 1-5, various views of a revolving tree stand system 100. FIG. 1 shows a revolving tree stand system 100 during an ‘in-use’ condition 150, according to an embodiment of the present disclosure. As illustrated, the revolving tree stand system 100 may include a seat assembly 110 including a hanger-member 112, a seat 114, and a shooting rail 116, a foot platform assembly 118 having a platform plate 120, a lower support arm assembly 122, a first-side mounting plate 124, a second-side mounting plate 126, and a tree-hugger assembly 128, and a hanger assembly 140 including an extension arm 142, a hook 144, and gripping members 146. The revolving tree stand system 100 provides a 360 degree rotatable tree hanger.

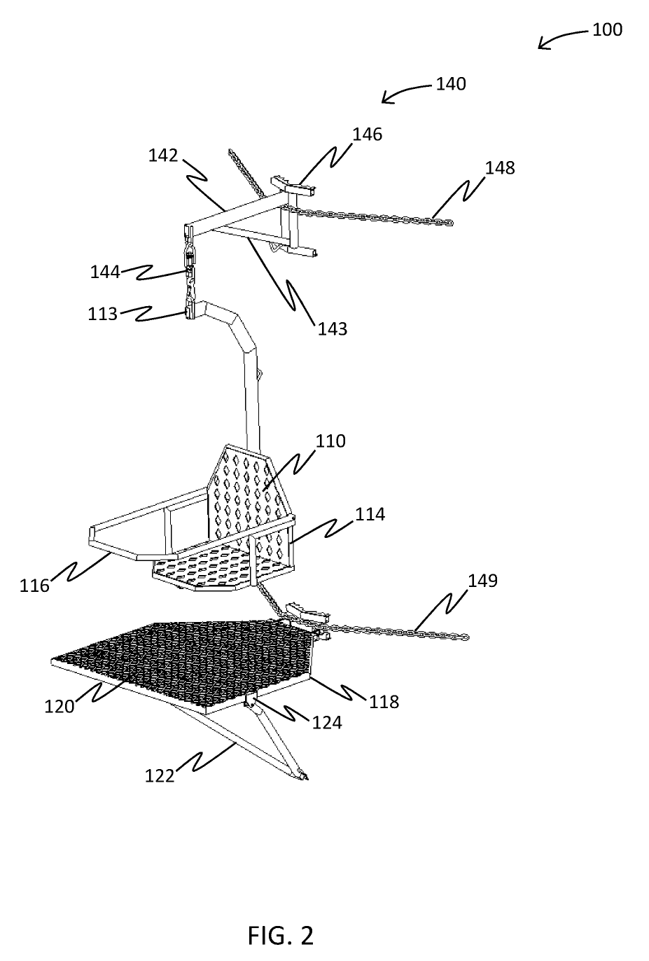

FIG. 2 shows a perspective view of the revolving tree stand system 100 of FIG. 1, according to an embodiment of the present disclosure. As above, the revolving tree stand system 100 may include the seat assembly 110, foot platform assembly 118, and hanger assembly 140 in functional combination. The hanger assembly 140 and the foot platform assembly 118 are configured to mount to a tree trunk using the gripping members 146 and the tree-hugger assembly 128 respectively, a first-chain 148, and second-chain 149. Other suitable fastening means may be used for securely mounting the device to the tree trunk. The first-chain 148 is configured to mount the hanger assembly 140 to the tree and the second-chain 149 is configured to mount the foot platform assembly 118 to the tree trunk. The extension arm 142 is connected to and extends from the gripping members 146 and includes the hook 144 at a distal end. The hanger assembly 140 further includes a reinforcing extension 143 for further supporting the extension arm 142. The reinforcing extension 143 connects to the extension arm 142 at an angle. The hanger assembly 140 is configured to receive and support the seat assembly 110 in a suspended position via the hook 144 connecting with the hanger-member 112. The seat assembly 110 is configured to support a user on the seat 114 and the platform plate 120 further supports the user.

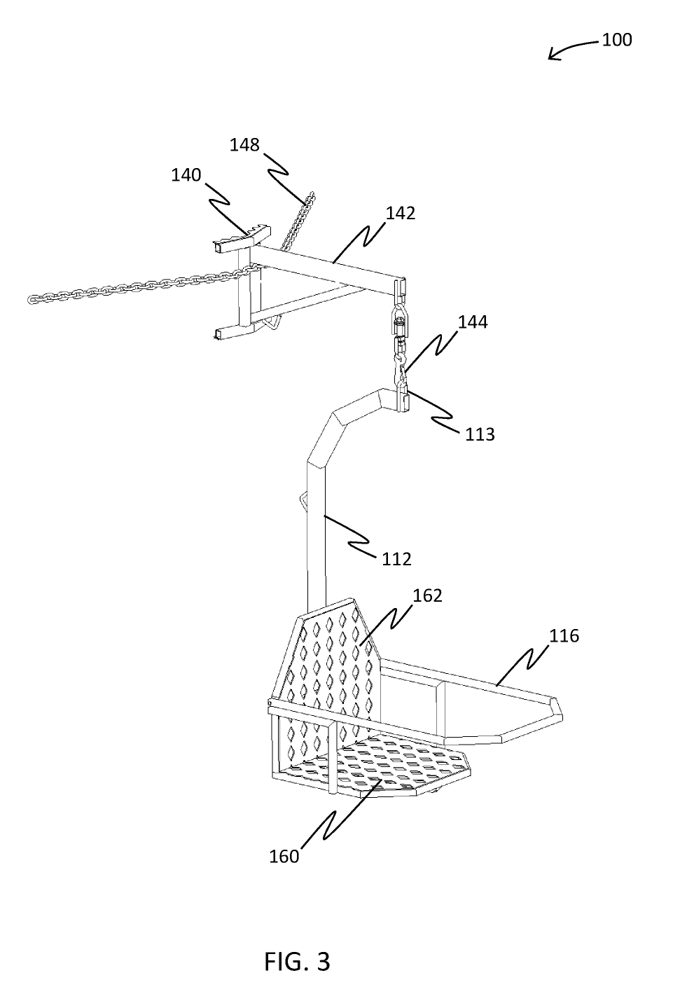

FIG. 3 shows a perspective view of the revolving tree stand system 100 of FIG. 1, according to an embodiment of the present disclosure. As above, the revolving tree stand system 100 may include the hanger assembly 140 supporting and suspending the seat assembly 110. The seat assembly 110 comprises the hanger-member 112, the seat 114, and the shooting rail 116. The seat 114 comprises a bottom-plate 160 and a back-plate 162. The hanger-member 112 of the seat assembly 110 comprises a curvature. The hanger-member 112 of the seat assembly 110 comprises a connector 113 for mounting the seat assembly 110 to the hook 144 of the hanger assembly 140. The hook 144 is configured to swivel and allow for 360 degree rotation. The hook 144 may include an eyehook. The shooting rail 116 extends comprises a c-shaped profile and extends from the seat to provide a gun support. The revolving tree stand system comprises metal materials suitable for supporting a weight of the user.

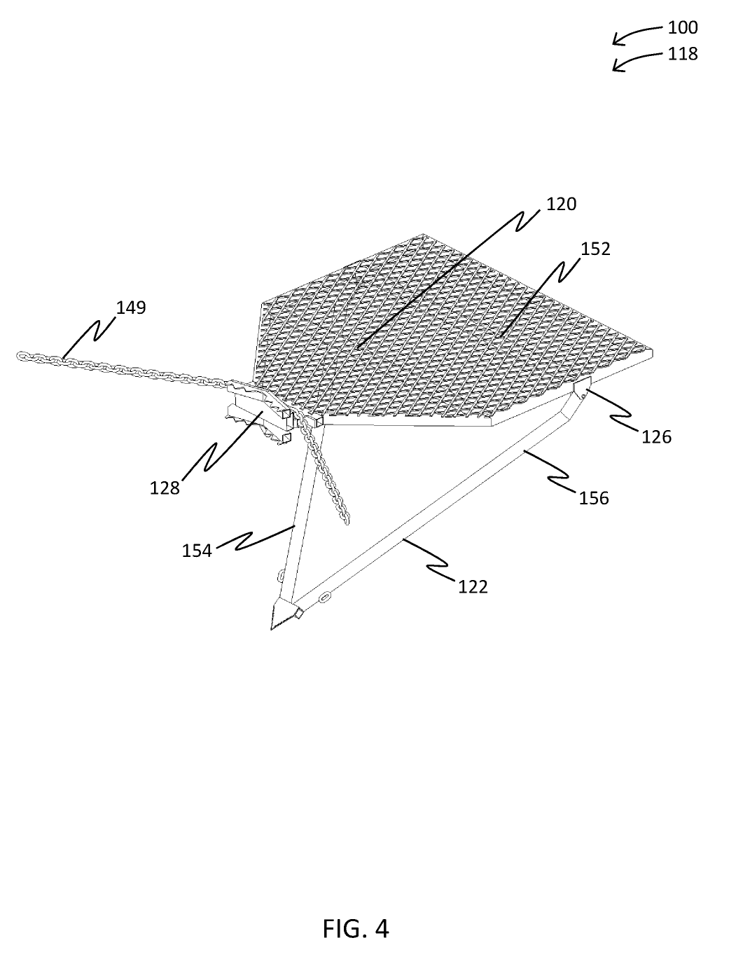

FIG. 4 shows a perspective view of the revolving tree stand system 100 of FIG. 1, according to an embodiment of the present disclosure. As above, the revolving tree stand system 100 may include the seat assembly 110 including the hanger-member 112, the seat 114, and the shooting rail 116, the foot platform assembly 118 having the platform plate 120, the lower support arm assembly 122, the first-side mounting plate 124, the second-side mounting plate 126, and the tree-hugger assembly 128, and the hanger assembly 140 including the extension arm 142, the hook 144, and the gripping members 146. The lower support arm assembly 122 is pivotally connected to the platform plate 120 via the first-side mounting plate 124 and the second-side mounting plate 126.

The lower support arm assembly 122 comprises a first-elongated-member 152, a second-elongated-member 154 and a third-elongated-member 156 together forming a triangular profile. The first-elongated-member 152 extends along an entire width of the platform plate 120. The second-elongated-member 154 and the third-elongated-member 156 meet at an apex. The second-elongated-member 154 and the third-elongated-member 156 are positioned at an adjustable angle relative to the platform plate 120. The tree-hugger assembly 128 of the foot platform assembly 118 is affixed to the platform plate 120. The gripping members 146 of the hanger assembly 140 and the tree-hugger assembly 128 of the foot platform assembly 118 comprise teeth for engaging with the tree trunk. The platform plate 120 comprises a wire metal grate. Additional support structures may be provided to support the platform plate 120.

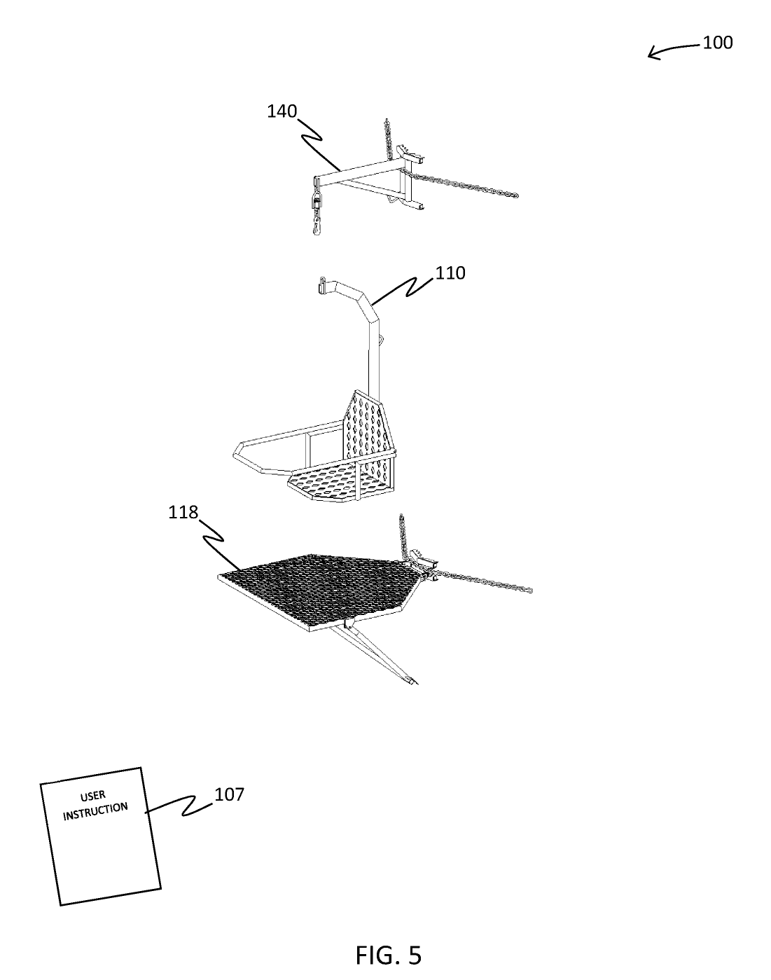

As shown in FIG. 5 the revolving tree stand system 100 may be arranged as a kit 105. In particular, the revolving tree stand system 100 may further include a set of instructions 107, a seat assembly 110, a foot platform assembly 118, a hanger assembly 140, a first-chain 148, and a second-chain 149. The instructions 107 may detail functional relationships in relation to the structure of the revolving tree stand system 100 such that the revolving tree stand system 100 can be used, maintained, or the like, in a preferred manner.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A revolving tree stand system comprising:
a seat assembly;
a hanger-member;
a seat; and
a shooting rail;
a foot platform assembly;
a platform plate;
a lower support arm assembly;
a first-side mounting plate;
a second-side mounting plate; and
a tree-hugger assembly; and
a hanger assembly including;
an extension arm;
a hook; and
gripping members;
wherein said revolving tree stand system comprises said seat assembly having said hanger-member, said seat, and said shooting rail, said foot platform assembly including said platform plate, said lower support arm assembly, said first-side mounting plate, said second-side mounting plate, and said tree-hugger assembly, and said hanger assembly including said chain, said extension arm, said hook, and said gripping members in functional combination;
wherein said hanger assembly and said foot platform assembly are configured to mount to a tree trunk using said gripping members and said tree-hugger assembly respectively, a first-chain, and second-chain;
wherein said first-chain is configured to mount said hanger assembly to said tree and said second-chain is configured to mount said foot platform assembly to said tree trunk;
wherein said extension arm is connected to and extends from said gripping members and includes said hook at a distal end;
wherein said hanger assembly is configured to receive and support said seat assembly in a suspended position via said hook connecting with said hanger-member;
wherein said seat assembly is configured to support a user on said seat and said platform plate further supports said user; and
wherein said revolving tree stand system provides a 360 degree rotatable tree hanger.

2. The revolving tree stand system of claim 1, wherein said seat comprises a bottom-plate and a back-plate.

3. The revolving tree stand system of claim 1, wherein said hanger-member of said seat assembly comprises a curvature.

4. The revolving tree stand system of claim 3, wherein said hanger-member of said seat assembly comprises a connector for mounting said seat assembly to said hook of said hanger assembly.

5. The revolving tree stand system of claim 4, wherein said hook is configured to swivel.

6. The revolving tree stand system of claim 5, wherein said hook includes an eyehook.

7. The revolving tree stand system of claim 1, wherein said lower support arm assembly is pivotally connected to said platform plate via said first-side mounting plate and said second-side mounting plate.

8. The revolving tree stand system of claim 7, wherein said lower support arm assembly comprises a first-elongated-member, a second-elongated-member and a third-elongated-member together forming a triangular profile.

9. The revolving tree stand system of claim 8, wherein said first-elongated-member extends along an entire width of said platform plate.

10. The revolving tree stand system of claim 9, wherein said second-elongated-member and said third-elongated-member meet at an apex.

11. The revolving tree stand system of claim 10, wherein said second-elongated-member and said third-elongated-member are positioned at an adjustable angle relative to said platform plate.

12. The revolving tree stand system of claim 1, wherein said tree-hugger assembly of said foot platform assembly is affixed to said platform plate.

13. The revolving tree stand system of claim 12, wherein said gripping members of said hanger assembly and said tree-hugger assembly of said foot platform assembly comprise teeth for engaging with said tree trunk.

14. The revolving tree stand system of claim 1, wherein said platform plate comprises a wire metal grate.

15. The revolving tree stand system of claim 1, wherein said shooting rail extends comprises a c-shaped profile and extends from said seat to provide a gun support.

16. The revolving tree stand system of claim 1, wherein said hanger assembly further includes a reinforcing extension for further supporting said extension arm.

17. The revolving tree stand system of claim 16, wherein said reinforcing extension connects to said extension arm at an angle.

18. The revolving tree stand system of claim 1, wherein said revolving tree stand system comprises metal materials suitable for supporting a weight of said user.

19. A revolving tree stand system, the revolving tree stand system comprising:
a seat assembly;
a hanger-member;
a seat; and
a shooting rail;
a foot platform assembly;
a platform plate;
a lower support arm assembly;
a first-side mounting plate;
a second-side mounting plate; and
a tree-hugger assembly; and
a hanger assembly including;
an extension arm;
a hook; and
gripping members;
wherein said revolving tree stand system comprises said seat assembly having said hanger-member, said seat, and said shooting rail, said foot platform assembly including said platform plate, said lower support arm assembly, said first-side mounting plate, said second-side mounting plate, and said tree-hugger assembly, and said hanger assembly including said chain, said extension arm, said hook, and said gripping members in functional combination;
wherein said hanger assembly and said foot platform assembly are configured to mount to a tree trunk using said gripping members and said tree-hugger assembly respectively, a first-chain, and second-chain;
wherein said first-chain is configured to mount said hanger assembly to said tree and said second-chain is configured to mount said foot platform assembly to said tree trunk;
wherein said extension arm is connected to and extends from said gripping members and includes said hook at a distal end;
wherein said hanger assembly is configured to receive and support said seat assembly in a suspended position via said hook connecting with said hanger-member;
wherein said hanger-member of said seat assembly comprises a curvature;
wherein said seat assembly is configured to support a user on said seat and said platform plate further supports said user;
wherein said revolving tree stand system provides a 360 degree rotatable tree hanger;
wherein said seat comprises a bottom-plate and a back-plate;
hanger-member of said seat assembly comprises a connector for mounting said seat assembly to said hook of said hanger assembly;
wherein said hook is configured to swivel;
wherein said hook includes an eyehook;
wherein said lower support arm assembly is pivotally connected to said platform plate via said first-side mounting plate and said second-side mounting plate;
wherein said lower support arm assembly comprises a first-elongated-member, a second-elongated-member and a third-elongated-member together forming a triangular profile;
wherein said first-elongated-member extends along an entire width of said platform plate;
wherein said second-elongated-member and said third-elongated-member meet at an apex;
wherein said second-elongated-member and said third-elongated-member are positioned at an adjustable angle relative to said platform plate;
wherein said tree-hugger assembly of said foot platform assembly is affixed to said platform plate;
wherein said gripping members of said hanger assembly and said tree-hugger assembly of said foot platform assembly comprise teeth for engaging with said tree trunk;
wherein said platform plate comprises a wire metal grate;
wherein said shooting rail extends comprises a c-shaped profile and extends from said seat to provide a gun support;
wherein said hanger assembly further includes a reinforcing extension for further supporting said extension arm;
wherein said reinforcing extension connects to said extension arm at an angle; and
wherein said revolving tree stand system comprises metal materials suitable for supporting a weight of said user.

20. The revolving tree stand system of claim 19, further comprising:
a seat assembly;
a foot platform assembly;
a hanger assembly;
a first-chain;
a second-chain; and
a set of instructions; and
wherein the revolving tree stand system is arranged as a kit.
